(19) United States
(12) Patent Application Publication
(10) Pub. No.: US 2026/0226880 A1
(43) Pub. Date: Aug. 6, 2026

(54) HYDROELECTRIC POWER HARVESTING APPARATUS

(71) Applicant: OAKES LTD, Wakefield Yorkshire (GB)

(72) Inventors: Frank OAKES, Wakefield Yorkshire (GB); Simon OAKES, Wakefield Yorkshire (GB)

(73) Assignee: OAKES LTD, Wakefield Yorkshire (GB)

(21) Appl. No.: 19/149,899

(22) PCT Filed: Feb. 21, 2024
(86) PCT No.: PCT/EP2024/054431

§ 371 Date: Jul. 22, 2025

(30) Foreign Application Priority Data
Feb. 22, 2023 (GB) 2302526.5

(51) Int. Cl. F03B 13/14

(52) U.S. Cl. CPC F03B 13/14; F05B 2220/706

(57) ABSTRACT

A hydroelectric power harvesting apparatus. The apparatus includes a support; a slide frame moveably coupled to the support; a float unit to float on a body of water having a movable water level; an energy generating mechanism; a float rocker arm coupled to the float unit and the energy generating mechanism. The float rocker arm is pivots about a pivot point on the slide frame. The float unit 104 moves with the water level of the body of water 106 to drive the float rocker arm to provide a work input to the energy generating mechanism. The slide frame is adjusts the level of the pivot point, float rocker arm, and the float unit.

### FIELD

This invention relates to a hydroelectric power harvesting apparatus and method of using the apparatus. The apparatus harvests power generated by movements of bodies of water, such as the sea or ocean, as provided by the tides and weather systems.

### BACKGROUND

Renewable technologies and infrastructure have seen significant growth and investment in recent years. This rapid expansion is the result of increased urgency to decarbonise our civilization in view of the challenges that will face humanity if anthropogenic climate change is allowed to continue on its current trajectory. Global electricity demand is currently growing faster than current renewable sources can provide, this shortfall increases the likelihood that non-renewables such as fossil fuels will be used, thereby increasing carbon emissions further.

Wind, solar, and hydroelectric sources are already widely used across the world. In Q2 of 2022, up to 38.6% of the UK's electricity demand was met using renewable sources. Despite the expansion of renewable infrastructure, utilization of the sea and oceans for power generation has seen comparatively little implementation despite Great Britain possessing well over 31,000 km of coastline.

Some examples of float-driven electricity generation systems exist that produce electricity by converting the power generated by bodies of water from their movements, as provided by the tides and weather systems and surrounding environmental undulations created therein. However, these systems lack flexibility in terms of adjustability of the float unit based on, for example, the conditions of the body of water or tides. Further, the systems are not adaptable to work with different conditions of the bodies of water in which they are used.

### SUMMARY

According to one example, there is provided a hydroelectric power harvesting apparatus comprises a support; a slide frame moveable coupled to the support; a float unit configured to float on a body of water having a movable water level; an energy generating mechanism; and a float rocker arm that is coupled to the float unit and the energy driving mechanism. The float rocker arm is configured to pivot about a pivot point on the slide frame. The float unit is configured to move as the water level of the body of water moves to drive the float rocker arm to provide a work input to the energy generating mechanism. The slide frame is configured to adjust the level of the pivot point, float rocker arm, and the float unit. This arrangement provides a simple configuration capable of extracting energy from a body of water. The arrangement harvests natural movement of the body of water.

Vertical movement of the float rocker arm and the float unit is provided by a slide frame coupled to a support. The slide frame is configured to adjust the vertical position of the float rocker arm and the associated float unit along the length of the support. Advantageously, the vertical position of the float unit and rocker arm may be adjusted in response the average or mean water level of the body of water based on tidal movement.

The apparatus may comprise a storm support and a storm cover. The float unit may be moveable on the slide frame into a parked position out of the body of water in a dormant state. While in this position, the float unit may be supported by the storm support and protected by the storm cover. The storm support and storm cover provide support and protection for the float unit. This may be useful in severe weather conditions, such as storms.

The float rocker arm may be extendable. The extendable float rocker may be configured to be extended or retracted to adjust a lever arm of the float unit from the pivot. Advantageously, the position of the float unit may be adjusted in the horizontal direction to adjust the amount of energy transferred from the body of water to the energy generating mechanism. This may allow for leveraged energy transfer depending on the intensity of the undulations provided by the body of water. The amount of extension may be adjusted to maintain a steady or constant energy input to the energy generating mechanism.

The float unit may be a volume-adjustable float unit, wherein increasing or decreasing the volume of the float alters the buoyancy of the float unit. By altering the buoyancy of the float unit, the force transferred by the float unit to the energy generating mechanism via the float rocker arm may be adjusted in response to the conditions of the body of water.

The apparatus may further comprise a controller configured to adjust the level of the float unit and the extension of the lever arm in response to the tide conditions of the body of water. This arrangement may provide for automatic adjustment of the vertical and horizontal position of the float rocker arm and float unit in response to the water level and conditions of the body of water. The controller may be configured to receive updates relating to tides and local conditions and make adjustments automatically.

The energy generation mechanism may be configured to transport water from the body of water to a higher level wherein the flow of water from the higher level to a lower level creates a fluid flow. By transferring water from the body of water to a higher level, the gravitational potential energy of the volume or mass of transferred water is increased. This extra potential energy and subsequent fluid flow may be harnessed to provide a useful work input. For example, the fluid flow may be used to drive a turbine to generate electricity. The fluid flow could be used to drive other useful mechanisms.

The apparatus may further comprise an electricity hydro-generator configured to extract energy from the fluid flow to generate electricity. The water transferred from the body of water to higher level may flow through the electricity hydro-generator to provide a useful work input to generate electricity. The generated electricity may be used locally or transferred to the national grid.

The higher level may be a reservoir configured to store the water transported by the energy generating mechanism. By storing water in a reservoir at a higher level, water may be stored and released at a later time to provide on-demand electricity generation. This on-demand approach to electricity generation could contribute to boosting base load electricity generation, or increasing capacity during peak usage times, thereby helping to reduce our reliance on non-renewable sources.

The reservoir may comprise at least one water level sensor to measure the quantity of water stored in the reservoir. By monitoring the quantity of water stored in the reservoir, the amount of potential electricity generation may be calculated based on the amount of stored water. Monitoring the water level in the reservoir may also allow for leak detection.

The reservoir may include a valve configured to provide control over the fluid flow. The valve may be used to provide control over the water flow passing out of the reservoir towards. This may in turn provide control over the amount of electricity being generated.

The energy generating mechanism may be one of at least one of bellows type pump; a single acting cylinder pump; a double acting cylinder pump; a single side acting peristaltic pump; a double side acting peristaltic pump; a direct drive pump; a direct mechanical drive pump. A direct mechanical drive pump may utilise at least one of a belt and pulley, sprocket and chain, rack and pinion, or piston drive arrangement, or the like. The specific type of pump may be chosen depending on the conditions of the body of water and the amount of water to be pumped in a single stroke. In some examples, multiple pump types and sizes may be used to suit a range of conditions. A combination of double and single action pumps may be used to suit a range of conditions and requirements. In one example, a bellows type pump may be used as this would be designed to stand repetitive usage.

The apparatus may comprise a shock absorber. The float unit may be coupled to the float rocker arm by the shock absorber. The shock absorber may provide a damping effect to forces acting on the float unit to reduce stresses acting on various joints and hinges within the arrangement, thereby reducing the likelihood of components being damage.

In one example, there is provided a method of using the apparatus to harvest energy from a body of water. The method includes the steps of transferring energy from the body of water to the energy generation mechanism; utilizing the generated energy by the energy generation mechanism to transfer water from the body of water to a higher level; utilizing the movement of the water from the higher level to a lower level to create a fluid flow; utilizing the fluid flow to drive an electricity hydro-generator to create electricity. This method provides a simple way of extracting energy from a body of water and converting that energy into useful work.

In one example, there is a hydroelectric power harvesting system configured to transfer the movement of a body of water to drive an energy generating mechanism via the use of a float and float rocker arm.

In one example, there is provided a height-adjustable float apparatus. The float apparatus includes a support and a slide frame moveable coupled to the support. The float apparatus includes one or more float units that are configured to float on a body of water and are connected to the support by a rocker arm at a pivot. The height of the pivot may be adjusted based on an average height of the body of water.

Any of the above features may be combined together in various combinations.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear. Reference signs incremented by 100 refer to the same components and for clarity, these may be used interchangeably to refer to the same component.

FIG. 1 shows a side-view of a hydroelectric power harvesting apparatus;

FIG. 2 shows a side-view of an embodiment of the hydroelectric power harvesting apparatus whereby the slide frame, float rocker arm, and float unit are in a position suitable for a low tide water level;

FIG. 3 shows a side-view of an embodiment of the hydroelectric power harvesting apparatus whereby the slide frame, float rocker arm, and float unit are in a position suitable for a high tide water level;

FIG. 4 shows a side-view of an embodiment of the hydroelectric power harvesting apparatus whereby the float unit is positioned in a dormant state;

FIG. 5 shows a side-view of an embodiment of the float unit, float rocker, and energy generating mechanism arrangement of the hydroelectric power harvesting apparatus whereby the float rocker arm is in a retracted state;

FIG. 6 shows a side-view of an embodiment of the float unit, float rocker, and energy generating mechanism arrangement of the hydroelectric power harvesting apparatus whereby the float rocker arm is in an extended or partially extended state;

FIG. 7 shows a side-view of an embodiment of the float unit, float rocker, and energy generating mechanism arrangement of the hydroelectric power harvesting apparatus whereby the float rocker arm, energy generating mechanism arm, and energy generating mechanism support are in an extended or partially extended state; and

FIG. 8 shows a flow diagram containing the steps for a method of generating hydro-electric power using the apparatus described herein.

### DETAILED DESCRIPTION

Hereinafter, various examples will be described with reference to the accompanying figures. The examples described below may be modified and implemented in various different forms. In order to more clearly describe features of the examples, detailed descriptions of matters well known to those skilled in the art to which the following examples belong will be omitted.

In the present disclosure, when an element is described as “connected” or “coupled” with another element, this includes not only “directly connected” or “directly coupled”, but also “connected with another element therebetween” or “coupled with another element therebetween”. In addition, when one element is described to “include” another element, this means that, unless specifically stated otherwise, the one element may further include other elements rather than excluding other elements.

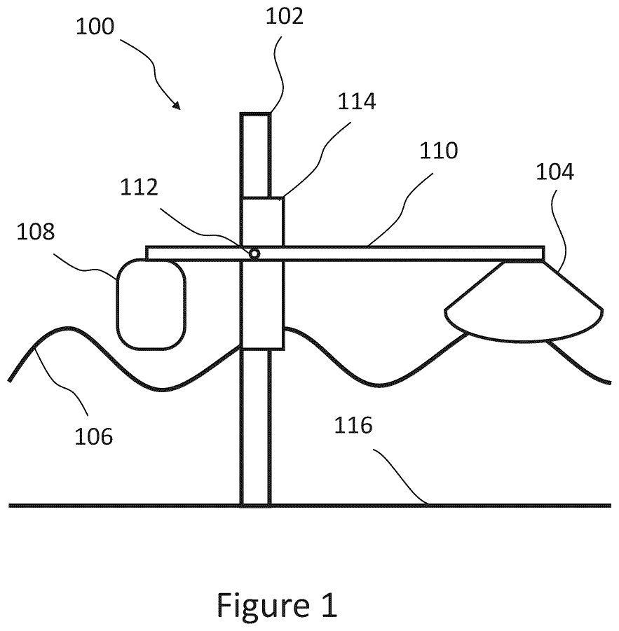

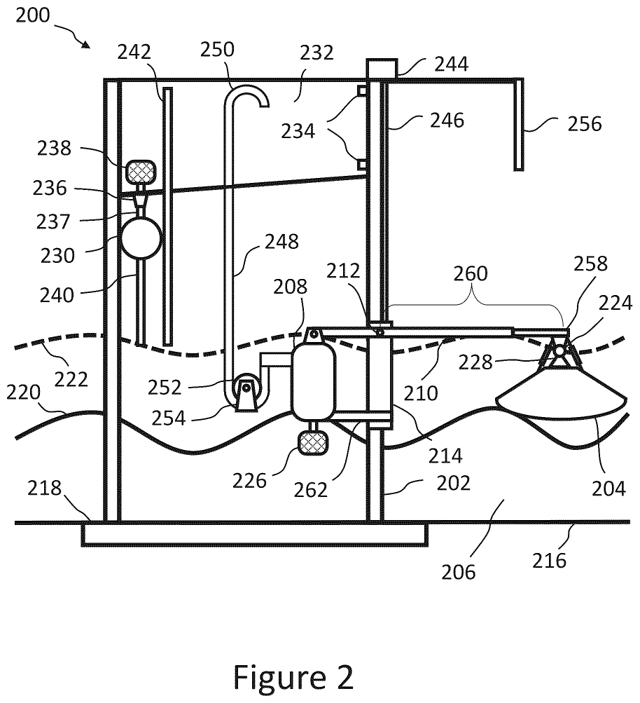

FIG. 1 illustrates an embodiment of a hydroelectric power harvesting apparatus 100. FIGS. 2 to 4 include additional components that may be included in the apparatus. The apparatus 100 comprises a support 102. The support 102 may comprise a plurality of support elements. The support 102 may be in the form of at least one support leg. The support 102 may act as a structure to which other components of the apparatus 100 as described herein may be attached, coupled, or connected.

The support 102 may be anchored into a substantially submerged surface such as a seabed 116, lakebed, or the like. As shown in FIG. 2, the support 102 may be anchored into a foundation 218 located on or embedded within the substantially submerged surface (such as the seabed 116).

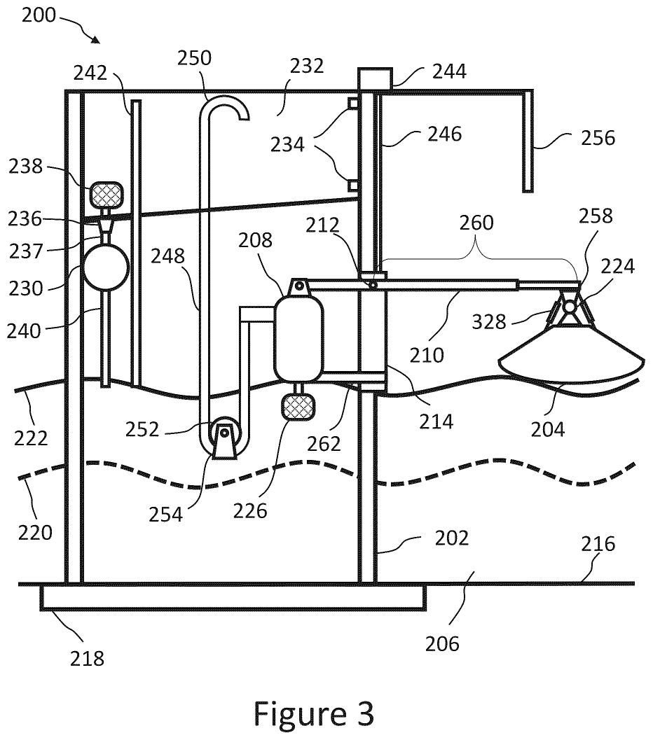

As shown in FIG. 1, the apparatus 100 further comprises a slide frame 114. The slide frame 114 is moveable coupled to the support 102. The slide frame 114 may achieve this by be configured to travel up and down the support 102 on a substantially vertical path. Movement of the slide frame 114 along the support 102 may be driven by a motor unit 244, as shown in FIG. 2. The motor unit 244 may operate a winch system 246 to adjust the vertical position of the slide frame 214 along the support 202. The winch system 246 may be a chain and sprocket type winch system or the like. Those skilled in the art will appreciate that alternative mechanisms may be used for the winch system 246 to achieve a substantially similar effect (for example a cable winch system, a ratchet winch system, and the like. Movement of the slide frame 114 may be continuous, for example, movement of the slide frame 114 may performed in line with the annual tide calendar. In one example, the slide frame 114 is moved to a position based on the average or mean level of the body of water 106 at a given time. For example, the body of water 106 may have an average water level of 10 m, but waves cause the water level to vary between 9.5 m and 10.5 m (note, these numbers are included purely to illustrate the example and are not limiting). In this case, the position of the slide frame 214 is based on the average water level. FIGS. 2 and 3 shows the slide frame and associated components at a low tide 220 position and high tide 222 positions, respectively.

As shown in FIG. 1, the apparatus 100 further comprises a float unit 104 configured to float on a body of water 106 having a movable water level. In this case, the moveable water level of the body of water 106 may occur as a result of wave action. In other words, the float unit 104 moves due to its buoyancy on the water. The extent of wave action will be dependent on weather conditions such as wind speed, temperature, storm activity, and the like. The wave action is configured to change the water level from an average water level of the body of water.

In another example, the float unit 104 may be a volume-adjustable float unit. In this example, the volume and/or surface area of the float unit 104 may be increased or decreased to provide a subsequent increase or decrease in the buoyant force acting upon the float unit 104 by the body of water 106. The float unit 104 may comprise at least two moveable sections configured to increase or decrease the volume of the float unit 104. The at least two sections of the float unit 104 may be actuated using a hydraulic mechanism. In one example, the at least two movable sections may concertina or be telescopic relative to one another so one movable section may be received within the other movable section. The skilled person will appreciate that alternative mechanisms may be used to provide a substantially similar result. This arrangement may provide flexibility regarding the amount of energy that may be harnessed from the wave action of the body of water 106. FIG. 2 shows that the average water level movement may be between a tidal range existing between high tide level 222 and low tide level 220. The low tide 220 level may be when the average level of the body of water 206 is at its lowest. The high tide 222 level may be when the average level of the body of water 206 is at its highest. The water level may rise and fall as a result of wave or tidal action. It will be appreciated that the tidal range is dependent on the geographical location of the apparatus 100, lunar cycle, and the like.

As shown in FIG. 1, the apparatus 100 further comprises an energy generating mechanism 108. The energy generating mechanism 108 may be coupled to the support 102. The energy generating mechanism 108 may be coupled to the support 102 via the slide frame 114. The energy generating mechanism 108 may be moveable with a float rocker arm 110 in a substantially vertical direction while maintaining a connection to the float rocker arm 110. The energy generating mechanism 108 may be coupled to the slide frame 114 via the float rocker arm 110 (described in more detail below). The energy generating mechanism 108 may be further coupled to the slide frame 114 by at least one support arm 262.

The energy generating mechanism 108 may be a pump. The energy generating mechanism 108 may be configured to pump water obtained from the body of water 106. The energy generating mechanism 108 may be one or more of a bellow pump; a single acting piston/cylinder type pump; a double acting piston/cylinder type pump; a single side acting peristaltic pump; a double side acting peristaltic pump; a direct drive pump; a direct mechanical drive pump, and the like. A direct mechanical drive pump may utilise at least one of a belt and pulley, sprocket and chain, rack and pinion, or piston drive arrangement, or the like. The skilled person will appreciate that various other mechanisms may be used that would result in a similar effect. The apparatus 100 may further comprise a plurality of energy generating mechanisms 108 to increase the amount of water pumped in each stroke.

As described above, the apparatus 100 further comprises a float rocker arm 110 that is coupled to the float unit 104 and the energy generating mechanism 108, as shown in FIG. 1. In other words, the float rocker arm 110 has a first end and a second end and is configured to be coupled to the float unit 104 at the first end and the energy generating mechanism 108 at the second end.

The float rocker arm 110 is configured to pivot about a pivot point 112 located on the slide frame 114, as shown in FIG. 1. That is to say that the float rocker arm 110 may be coupled to the pivot point 112 at a position in between the first end and the second end of the float rocker arm 110. This arrangement allows the level of the float rocker arm 110 and float unit 104 to be raised and lowered by moving the slide frame 114 up or down the support 102. Such adjustment may be applied in response to changing tide conditions of the body of water 106. These adjustments may also be required in response to adverse weather conditions, such as stormy weather or strong winds, which may cause the water level of the body of water to significantly change as a result of wave action.

The apparatus 100 may comprise one or more sub-float rocker arms 110 coupled to an equivalent number of energy generating mechanisms 108 to increase the amount of water pumped per stroke. Alternatively, a single float rocker arm 110 may be configured to provide multiple work inputs to at least one energy generating mechanism 108.

The apparatus 100 may comprise a gear mechanism (not shown). The gear mechanism may be arranged between the float rocker arm 110 and the energy generating mechanism 108. The gear mechanism may be configured to provide mechanical advantage to a work input provided by the float rocker arm 110, thereby providing an increased work input to the energy generating mechanism 108.

As shown in FIG. 2, the apparatus 200 may further comprise a shock absorber 228. The shock absorber 228 may couple the float unit 204 to the float rocker arm 210. The shock absorber 228 may be configured to reduce stresses acting on the float unit 204 and float rocker arm 210 by damping the impacts of wave activity. As further shown in FIG. 2, the float unit may also be coupled to the float rocker arm 210 by a float unit pivot 224. The float unit pivot 224 may be configured to allow swaying of the float unit 204 as it interacts with the body of water 206. The float unit pivot 224 may further improve the damping effect provided by the shock absorber 228. The shock absorber 228 may use hydraulic, spring, or equivalent damping mechanisms.

As mentioned above, the float unit 104 is configured to move as the water level of the body of water 106 moves. The movement of the float unit 104 and float rocker arm 110 may be primarily driven by wave action of the body of water 106. This movement drives the float rocker arm 110 to provide a work input to the energy generating mechanism 108. The water level of the body of water 106 may also move due to tidal changes, this may affect the extent of movement of the float unit 104 and the rocker arm 110.

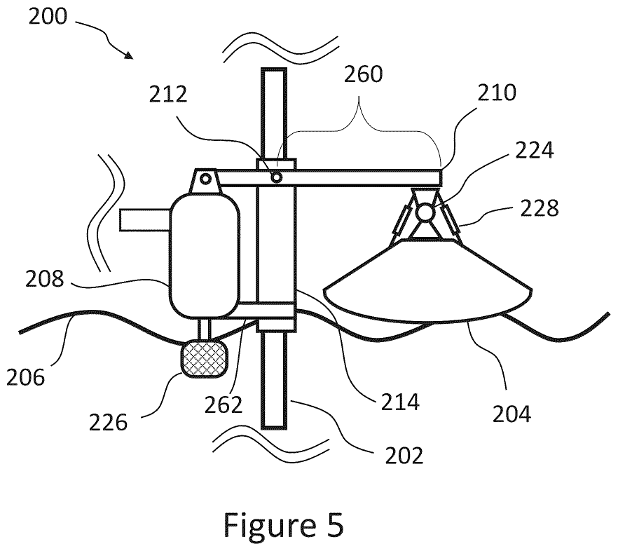

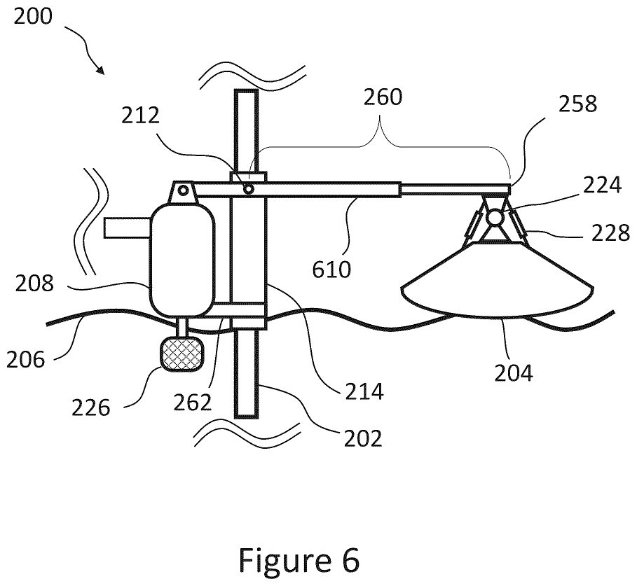

As shown in FIGS. 2, 3, and 6, the float rocker arm 210 may be an extendable float rocker arm configured to be extended or retracted to adjust ta lever arm 260 of the float unit 204 from the pivot point 212. The float rocker arm 210 may comprise a first extending portion 258 configured to extend from a first end of the float rocker arm 210. For example, the float rocker arm 210 may be telescopic to allow it to be extendable from a fully retracted position (FIG. 5) to an a partially or fully extended position (FIG. 6). The first extending portion 258 of the float rocker arm 204 may be configured to be extended or retracted at the first end to adjust a lever arm 260 extending from the pivot point 212 to the float unit 204. Extension or retraction of the first extending portion 258 of the float rocker arm 210 may increase or decrease the mechanical leverage provided by the lever arm 260. Extension or retraction of the first extending portion 258 of the float rocker arm 210 may be applied in response to different wave conditions of the body of water 206. In an example, where wave size is small, the first extending portion 258 of the float rocker arm 210 may be extended to increase the mechanical leverage provided, thereby causing a respective increase to the work input provided to the energy generating mechanism 208. In another example, when wave size is large, the first extending portion 258 may be retracted to reduce the mechanical leverage provided, thereby causing a respective decrease to the work input provided to the energy generating mechanism 208. Adjustment of the length of the lever arm 260 by extension or retraction of the first extending portion 258 may be used to provide a more consistent work input to the energy generating mechanism 208 regardless of the conditions of the body of water 206.

The energy generating mechanism 108 is configured to receive a work input from the float rocker arm 110 in use. The energy generating mechanism 108 may be configured to convey water from the body of water 106 to a higher level. The water may be allowed to flow from the higher level to a lower level, thereby creating a fluid flow. The fluid flow may be harnessed to provide a useful work input.

As shown in FIG. 2, the apparatus 200 may further comprise an electricity hydro-generator 230. The electricity hydro-generator 230 may be configured to extract kinetic energy from a fluid flow to generate electricity. The electricity hydro-generator 230 may be a turbine. The apparatus 200 may comprise a plurality of electricity hydro-generators 230 to increase its capacity for the production of electricity.

As further shown in FIG. 2, the apparatus 200 may further comprise a reservoir 232 configured to store water. The reservoir 232 may be located at the higher level. In other words, the reservoir may be the higher level to which water is conveyed. The energy generating mechanism 108 may transport water to the reservoir 232 located at the higher level.

As further shown in FIG. 2, the reservoir 232 may comprise at least one water level sensor 234 configured to measure water within the reservoir. The at least one water level sensor 234 may be a high-water level sensor. The at least one water level sensor 234 may be a low-water level sensor. The water level data may be used to calculate of a volume of water stored in the reservoir 232. The water level data may be used to determine calculate the amount of electricity that can be generated using the volume of water stored in the reservoir 232.

As further shown in FIG. 2, the reservoir 232 may comprise at least one valve 236. The at least one valve 236 may be configured to provide control of the flow of water from the reservoir 232 at the higher level to a lower level. The lower level may be the body of water 106. The at least one valve 236 maybe be a solenoid actuated valve; however, the skilled person will appreciate that other valves may be used to achieve a substantially similar result Water may be transported from the reservoir 232 to the electrical hydro-generator 230 via at least one reservoir outfeed pipe 237. The water may pass through a reservoir filter 238 configured to filter the water passing from the higher level or reservoir 232 towards the electricity hydro-generator 230. The at least one valve 236 may be actuated to release water to provide electricity generation on-demand.

The reservoir 232 may be positioned at an elevation higher than the electricity hydro-generator 230. The flow of water from the higher level or reservoir 232 to a lower level, such as the body of water 106, may be routed via the electricity hydro-generator 230 to provide a work input for the generation of electricity. Water passed through the electricity hydro-generator 230 may be transported to the lower level or body of water 106 by way of an electricity hydro-generator outfeed pipe 240.

As illustrated in FIG. 2, the reservoir 232 may further comprise an overflow pipe 242 configured to transport excess water from the reservoir 232 back to the body of water 106 if the amount of water inside the reservoir 232 reaches a level above the top of the overflow pipe 242. The overflow pipe 242 may be height adjustable within the reservoir to alter the threshold water level required before water is able to flow through the overflow pipe 242.

As shown in FIG. 2, the apparatus 100 may further comprise an outfeed pipe 248 and delivery pipe 250 configured to provide fluid communication between the energy generating mechanism 108 and the higher level or reservoir 232. The outfeed pipe 248 may be a flexible outfeed pipe 248. The apparatus may further comprise a guide wheel 252 and tensioner weight 254 configured to moderate the movement of the flexible outfeed pipe 248 by allowing automatic adjustment of the flexible outfeed pipe 248 in response to movement of the energy generating mechanism 108 on the slide frame 114.

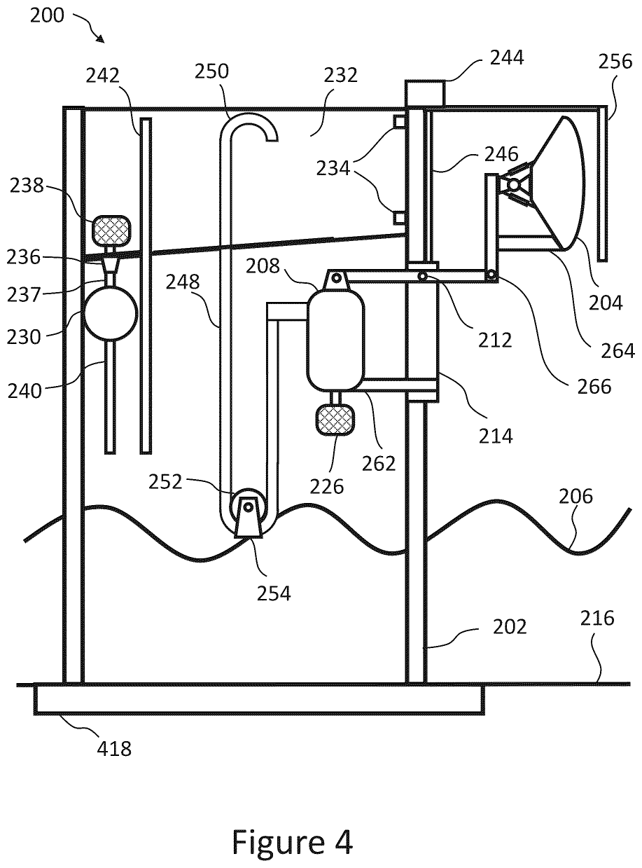

As shown in FIGS. 2 to 4, the apparatus 200 may further comprise a storm cover 256 and a storm support 264. The float rocker arm 210 may further comprise a float rocker arm hinge 266, configured to allow the float rocker arm to fold to allow positioning of the float unit 204 behind the storm cover 256. The storm support 264 may be coupled to the float rocker arm 210 and be configured to support the float unit 204 when the float rocker arm 210 is in a folded arrangement. The storm cover 256 may be configured to protect the float unit 204 from unfavourable weather conditions, such as storms and/or strong winds, when the float unit 204 is in a dormant state. When the float unit is in the dormant state, the float rocker arm 210 may be fully retracted; the slide frame 214 may be raised to its highest position on the support 202 into a parked position; the float rocker arm 210 may be in a folded using the float rocker arm hinge 266; and the float unit 204 may be supported by the storm support 264. This arrangement is shown in FIG. 4, as shown, the storm cover 256 is configured to provide the float unit 204 with protection from multiple directions, including from above and at least one side. The storm cover 256 may be further configured to provide the float unit 204 with protection on each side and from behind.

As mentioned above, the float rocker arm 210 may comprise a first extending portion 258 at a first end. The float rocker arm 210 may further comprise a second extending portion 268 at a second end.

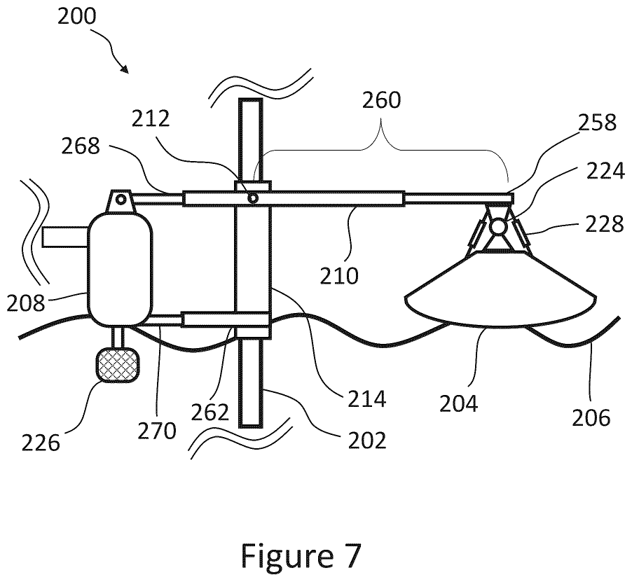

As shown in FIG. 7, the second extending portion arm 268 may be telescopic to allow it to be extendable from or retractable within the float rocker arm 210, although other examples are envisaged. The energy generating mechanism 208 may be coupled to the slide frame via the second extending portion 268 of the float rocker arm 210. The energy generating mechanism 208 may be further coupled to the slide frame 214 by a support arm 262. The support arm 262 may further comprise an extendable support arm section 270. The extendable support arm section 270 may be telescopic to allow it to be extendable from or retractable within the support arm 262.

FIG. 5 shows the float rocker arm 210 in a retracted state, whereby the first extending portion 258 is telescopically retracted within the float rocker arm 210 and the lever arm 260 is at its shortest length. In this arrangement, the support arm 262 may also be in a retracted state.

FIG. 6 shows the float rocker arm 210 in an extended state, whereby the first extending portion 258 is partially or fully extended from within the float rocker arm 210. Extension of the first extending portion 258 may increase the length of the lever arm 260. By increasing the length of the lever arm 260, the mechanical leverage provided by the float rocker arm 210 can be increased, thereby increasing the force applied to the energy generating mechanism 208.

FIG. 7 shows the float rocker arm 210 in an extended state, whereby the first extending portion 258 is partially or fully extended from within the float rocker arm 210. In this arrangement, the second extending portion 268 is also partially or fully extended from within the float rocker arm 210. In this arrangement, the support extending portion 270 is also partially or fully extended from within the support arm 262. The second extending portion 268 and support extending portion 270 may be extended to adjust the horizontal position of the energy generating mechanism 208 to provide counterbalance against the weight of the float unit 204 when the first extending portion 258 is in an extended state.

The apparatus 100 may further comprise a controller (not shown). The controller may be configured to control the slide frame 114 to adjust the level of the float unit 104. Movement of the slide frame 114 will adjust the pivot point 112, which in turn will result in movement of the other associated components, namely, the float unit 104, the float rocker arm 110 and the energy generating mechanism 108. The controller may be configured to continuously adjust the level of the slide frame 104 and associated components by altering the vertical position of the slide frame 114. The controller may be configured to make said adjustments in response to the tide conditions of the body of water 106 according to local weather information, for example, stormy weather or strong winds.

The controller may be further configured to adjust the extension or retraction of the first extending portion 258, thereby altering the length of the lever arm 260. The controller may be further configured to adjust the extension or retraction of the second extending portion 268 and support extending portion 270. The controller may be configured to make said adjustments in response to the tide conditions of the body of water 206 according to an annual tide schedule. The controller may be configured to make said adjustments in response to the tide conditions of the body of water 206 according to local weather information, for example, stormy weather or strong winds. The controller may be configured to obtain further environmental or water level information about the body of water 206 from other sources, such as sensors on the exterior of the apparatus 200.

The controller may be further configured to adjust the volume of a volume-adjustable float unit 104. The controller may be configured to make said adjustments in response to the tide conditions of the body of water 106 according to an annual tide schedule. The controller may be configured to make said adjustments in response to the local weather conditions, such as storms or high winds. The controller may be configured to receive up-to-date local weather and tide data.

The controller may be configured to receive water level data from the at least one water level sensor 234. The controller may be configured to utilize the water level data to calculate of a volume of water stored in the reservoir 232. The controller may be further configured to utilize the water level data to determine calculate the amount of electricity that can be generated using the volume of water stored in the reservoir 232.

The controller may be further configured to control the least one valve 236 to allow a pre-determined volume of water leave the reservoir 232.

As shown in FIG. 2, the apparatus 100 may further comprise a filter 226 coupled to the energy generating mechanism 208. The filter 226 may be configured to filter water from the body of water 206 as it is drawn into the energy generating mechanism 208.

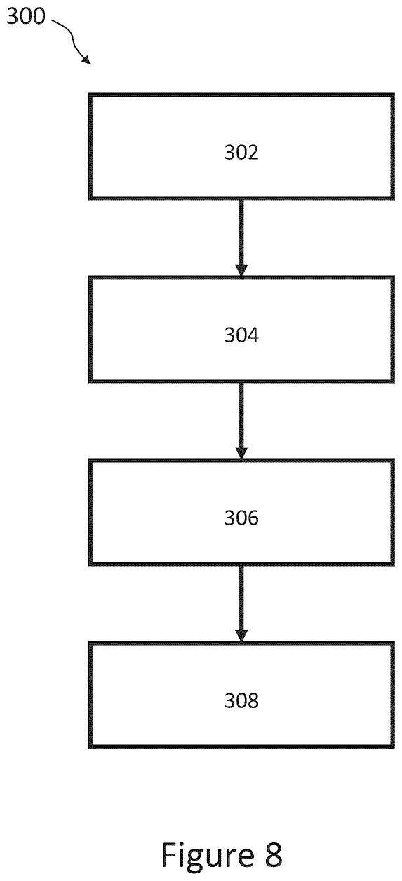

A method 300 of using the hydroelectric power harvesting apparatus 100 is shown in FIG. 8. Step 302 of the method 300 may involve transferring energy from the body of water 106 to the energy generation mechanism 108. Step 304 of the method 300 may further involve utilizing the energy generated by the energy generation mechanism 108 to transfer water from the body of water 106 to a higher level. Step 304 of the method 300 may further involve utilizing the movement of water from the higher level to a lower level to create a fluid flow. Finally, step 306 of the method 300 may involve utilizing the fluid flow to drive an electricity hydro-generator 230 to create electricity.

The apparatus 100 as described herein may be one of a plurality of hydroelectric power harvesting apparatuses arranged to form a hydroelectric power plant. The plurality of apparatuses may be organized in an offshore harbour arrangement. The offshore harbour may comprise connections to the coastline. Alternatively, the plurality of apparatuses may be organized in a sea wall arrangement. The plurality of apparatuses may comprise a connection to the national grid and be configured to feed electricity into the national grid. The plurality of apparatuses may be coupled to a cliff and configured to pump water up to a canal. The power plant may be used by boats, ships, or other nautical vessels to recharge.

The apparatus 100 as described herein may be attachable to the supporting structures of oil platforms, wind turbines, and other fixed sea/ocean-based structures. The apparatus 100 may be further comprise a docking portion (not shown) to enable a boat, ship, or other water-based vehicles to be attached or docked to the apparatus 100. The apparatus 100 may be used to charge or top-up the batteries of docked boats, ships, or other vehicles.

The apparatus 100 described herein may be attachable, via the support 102, directly to the seabed 116 or other surface beneath the body of water 106. For example, the support 102 may extend into the seabed 116. Alternatively, the apparatus 100 may be attachable, via the support 102, to the seabed 116 via a flexible linkage (not shown). The flexible linkage may be a rope, chain, or equivalent apparatus having a fixed length. The flexible linkage may provide the apparatus 100 with some movement on the surface of the body of water 106.

Reference in the specification to “an example”, “an embodiment”, “an aspect” or similar language means that a particular feature, structure, or characteristic described in connection with the example is included in at least one example, but not necessarily in other examples. The various instances of the phrase “in one example” or similar phrases in various places in the specification are not necessarily all referring to the same example. In describing and claiming examples disclosed herein, the singular forms “a”, “an”, and “the” include plural references unless the context clearly dictates otherwise.

While several examples have been described in detail, it is to be understood that the disclosed examples may be modified. Therefore, the foregoing description is to be considered non-limiting. It should be understood that the examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made.

1-12. (canceled)

13. A hydroelectric power harvesting apparatus, comprising:
a support;
a slide frame moveably coupled to the support;
a float unit configured to float on a body of water having a movable water level;
wherein the float unit is a volume-adjustable float unit, wherein increasing or decreasing the volume of the float unit alters the buoyancy of the float unit,
an energy generating mechanism;
a float rocker arm that is coupled to the float unit and the energy generating mechanism and wherein the float rocker arm is configured to pivot about a pivot point on the slide frame;
wherein the float unit is configured to move as the water level of the body of water moves to drive the float rocker arm to provide a work input to the energy generating mechanism,
wherein the slide frame is configured to adjust the level of the pivot point, float rocker arm and the float unit.

14. The apparatus of claim 13, further comprising a storm support and a storm cover, wherein the float unit is moveable on the slide frame into a parked position out of the body of water in a dormant state, wherein the float unit is supported by the storm support and protected by the storm cover.

15. The apparatus of claim 13, wherein the float rocker arm is extendable and is configured to be extended or retracted to adjust a lever arm of the float unit from the pivot.

16. The apparatus of claim 13, wherein the apparatus further comprises a controller configured to adjust the level of the float unit and extension of the lever arm in response to the tide conditions of the body of water.

17. The apparatus of claim 13, wherein the energy generating mechanism is configured to transport water from the body of water to a higher level, wherein the flow of water from the higher level to a lower level creates a fluid flow.

18. The apparatus of claim 17, further comprising an electricity hydro-generator configured to extract energy from the fluid flow to generate electricity.

19. The apparatus of claim 17, wherein the higher level is a reservoir configured to store the water transported by the energy-generating mechanism.

20. The apparatus of claim 20, wherein the reservoir comprises at least one water level sensor to measure the quantity of water stored in the reservoir.

21. The apparatus of any of claims 20, wherein the reservoir includes a valve configured to provide control over the fluid flow.

22. The apparatus of claim 13, wherein the energy generating mechanism is at least one of a bellows type pump; a single acting cylinder pump; a double acting cylinder pump; a single side acting peristaltic pump; a double side acting peristaltic pump; a direct drive pump; a direct mechanical drive pump,
wherein when the pump is a direct mechanical drive pump, the pump utilises at least one of a belt and pulley, sprocket and chain, rack and pinion, or piston drive arrangement.

23. The apparatus of claim 13, further comprising a shock absorber, wherein the float unit is coupled to the float rocker arm by the shock absorber.

24. A method of using the apparatus of claim 13 to harvest energy from a body of water, comprising:
transferring energy from the body of water to the energy generation mechanism;
utilizing the energy generated by the energy generation mechanism to transfer water from the body of water to a higher level;
utilizing the movement of water from the higher level to a lower level to create a fluid flow;
utilizing the fluid flow to drive the electricity hydro-generator to create electricity.
